(19) United States
(12) Patent Application Publication
(10) Pub. No.: US 2010/0005311 A1
(43) Pub. Date: Jan. 7, 2010

(54) Electronic-data authentication method, Elctronic-data authentication program, and electronic-data, authentication system

(75) Inventor: Taiji Okamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,382

(22) Filed: Sep. 14, 2009

Related U.S. Application Data
(63) Continuation of application No. PCT/JP2008/051937, filed on Feb. 6, 2008.

(30) Foreign Application Priority Data
Mar. 30, 2007 (JP) 2007-094523

(51) Int. Cl. H04L 9/32; G06F 21/00

(52) U.S. Cl. 713/176

(57) ABSTRACT

An electronic-data authentication method is for authenticating electronic data provided by a virtual person anonymously used on a network, performed by a virtual-person management system including a user terminal, a user management device, and a virtual-person management device. The method includes receiving, by the virtual-person management device, the electronic data, a first electronic signature generated by encrypting the electronic data with a first signature-creation key, and an virtual person ID for uniquely identifying the virtual person from the user terminal; authenticating, by the user management device, the first electronic signature received at the receiving by using a first signature-authentication key corresponding to the first signature-creation key; generating, by the virtual-person management device, a second electronic signature by encrypting the electronic data received at the receiving with a second signature-creation key issued for the virtual person; and transmitting, by the virtual-person management device, the second electronic signature to the user terminal.

### CROSS-REFERENCE TO RELATED APPLICATION(S)

This application is a continuation of PCT international application Ser. No. PCT/JP2008/051937 filed on Feb. 6, 2008 which designates the United States, incorporated herein by reference, and which claims the benefit of priority from Japanese Patent Application No. 2007-094523, filed on Mar. 30, 2007, the entire contents of which are incorporated herein by reference.

### FIELD

The embodiments discussed herein are directed to an electronic-data authentication method, an electronic-data authentication program, and an electronic-data authentication system that are useful for authenticating electronic data provided by a virtual person anonymously used on a network.

### BACKGROUND

Conventionally, to prevent personal information of a user from leaking to a third person, there is provided a system that allows the user to anonymously engage in buying and selling a product or writing a message on a bulletin board on the Internet. For example, Japanese Laid-open Patent Publication No. 2002-123633 discloses a system in which information indicating a correspondence relationship between a virtual person anonymously used on a network and an actual person is registered in a predetermined organization that has a confidentiality obligation, so that the person can open a bank account, make credit settlement, deliver or receive a product, and the like, as the virtual person. Furthermore, Japanese Laid-open Patent Publication No. 2002-132148 discloses an authentication method using an electronic signature with a public-key encryption method.

The user uses the virtual person because anonymity of the virtual person is attractive to the user. Specifically, the user can conceal personal information of the user by using the virtual person. However, if a conventional authentication method using an electronic signature is employed for electronic data provided by the virtual person, a public key of the user who is the owner of the virtual person is disclosed to the public. Moreover, an electronic certificate for authenticating the public key needs to be issued by a predetermined authentication organization. Therefore, there is a possibility of leakage of information that can identify the owner of the anonymous virtual person due to the presence of the public key.

Furthermore, in a conventional system, because it is considered that the virtual person is associated with the actual person, there is no consideration for assignment of the virtual person to a third person. However, as the user operates as the virtual person on the network, it is possible that the virtual person itself obtains credibility and a financial worth is found with respect to the credibility. For example, assuming that the virtual person is assigned to a third person, in the conventional authentication method using the electronic signature, each time the owner of the virtual person is changed, a public key of a user who is the current owner of the virtual person is changed to a public key of a user who is a new owner of the virtual person. Therefore, because the change of the public key is disclosed to outsiders, it is possible to guess that the owner of the virtual person has been changed. As a result, it is possible for a third person to analyze a difference in behavior characteristics of the virtual person around the time when the owner is changed, which can affect the credibility included in the financial worth of the virtual person.

### SUMMARY

According to an aspect of the invention, an electronic-data authentication method for authenticating electronic data provided by a virtual person anonymously used on a network, performed by a virtual-person management system including a user terminal, a user management device, and a virtual-person management device. The electronic-data authentication method includes receiving, by the virtual-person management device, the electronic data, a first electronic signature generated by encrypting the electronic data with a first signature-creation key, and an virtual person ID for uniquely identifying the virtual person from the user terminal; authenticating, by the user management device, the first electronic signature received at the receiving by using a first signature-authentication key corresponding to the first signature-creation key; generating, by the virtual-person management device, a second electronic signature by encrypting the electronic data received at the receiving with a second signature-creation key issued for the virtual person; and transmitting, by the virtual-person management device, the second electronic signature to the user terminal.

According to another aspect of the invention, an electronic-data authentication method for authenticating electronic data provided by a virtual person anonymously used on a network, performed by a virtual-person management system including a user terminal, a user management device, a virtual-person management device, and a service providing device. The electronic-data authentication method includes receiving, by the service providing device, the electronic data, a first electronic signature generated by encrypting the electronic data with a first signature-creation key, and an virtual person ID for uniquely identifying the virtual person from the user terminal; receiving, by the virtual-person management device, the electronic data, the first electronic signature, the virtual person ID from the service providing device, authenticating, by the user management device, the first electronic signature by using a first signature-authentication key corresponding to the first signature-creation key; generating, by the virtual-person management device, a second electronic signature by encrypting the electronic data received by the virtual-person management device with a second signature-creation key issued for the virtual person; and transmitting, by the virtual-person management device, the second electronic signature to the service providing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a system block diagram of a virtual-person management system;

FIG. 2 is a functional block diagram of a virtual-person management device according to a first embodiment of the present invention;

FIG. 3 is a diagram of data formation of a virtual-person information file;

FIG. 4 is a diagram for explaining a format example of a virtual-person electronic certificate;

FIG. 5 is a diagram for explaining information set in main items contained in the virtual-person electronic certificate;

FIG. 6 is a functional block diagram of a user management device according to the first embodiment;

FIG. 7 is a diagram of data formation of a user information file;

FIG. 8 is a sequence chart for explaining an operation performed when a virtual person ID is issued;

FIG. 9 is a sequence chart for explaining a key creation operation performed by the virtual-person management device and the user management device;

FIG. 10 is a sequence chart for explaining an example of an operation performed when electronic data is authenticated;

FIG. 11 is a schematic diagram for explaining a first electronic-signature generation operation performed by a user terminal A as represented in FIG. 10;

FIG. 12 is a schematic diagram for explaining a first authentication operation performed by a user management device A as represented in FIG. 10;

FIG. 13 is a schematic diagram for explaining a second electronic-signature generation operation performed by the virtual-person management device as represented in FIG. 10;

FIG. 14 is a schematic diagram for explaining a second authentication operation performed by a user terminal B as represented in FIG. 10;

FIG. 15 is a sequence chart for explaining an example of the operation performed when the electronic data is authenticated;

FIG. 16 is a block diagram of a computer that executes an electronic-data authentication program;

FIG. 17 is a functional block diagram of a virtual-person management device according to a second embodiment of the present invention;

FIG. 18 is a diagram for explaining information set in the main items contained in the virtual-person electronic certificate in the case of a common-key encryption method;

FIG. 19 is a schematic diagram for explaining the second authentication operation in the case of the common-key encryption method;

FIG. 20 is a schematic diagram for explaining the second authentication operation performed by the virtual-person management device as depicted in FIG. 19; and

FIG. 21 is a schematic diagram for explaining an authentication-result notification information generation operation performed by the virtual-person management device as depicted in FIG. 19.

### DESCRIPTION OF EMBODIMENT(S)

Preferred embodiments of the present invention will now be described in detail of an electronic-data authentication method, an electronic-data authentication program, and an electronic-data authentication system with reference to the accompanying drawings.

### [a] First Embodiment

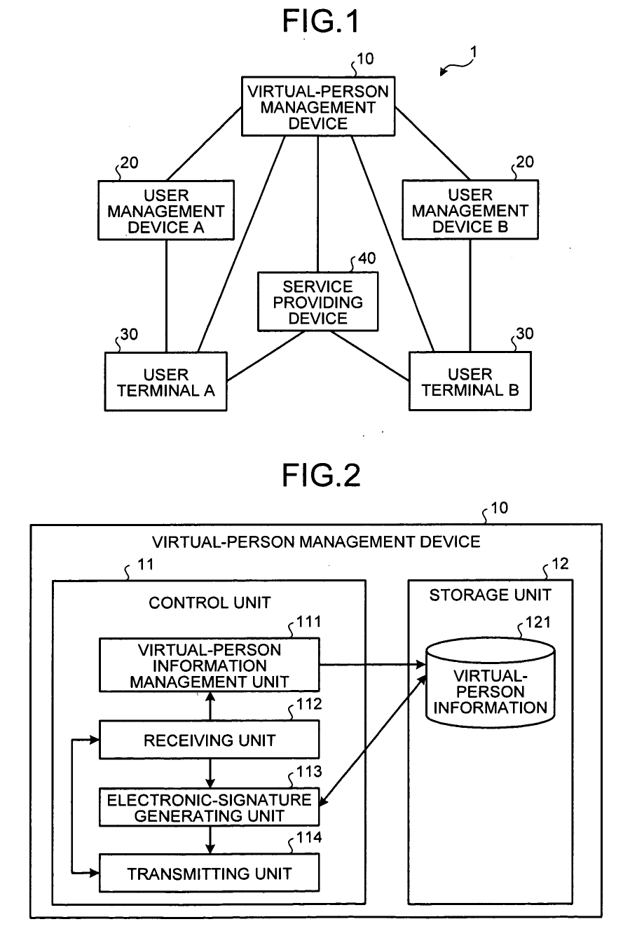

A configuration of a virtual-person management system 1 according to a first embodiment of the present invention will be explained below. FIG. 1 is a system block diagram of the virtual-person management system 1. As depicted in FIG. 1, the virtual-person management system 1 includes a virtual-person management device 10, user management devices 20, user terminals 30, and a service providing device 40. In the following description, an explanation will be given for the virtual-person management system 1 in which, for example, if a user terminal A provides the service providing device 40 with electronic data generated by a virtual person, a third person who has acquired the electronic data from the service providing device 40 can confirm that the electronic data is undoubtedly a product material generated by the virtual person, and information for identifying an owner of the virtual person can be prevented from being leaked to outsiders upon provision of the electronic data. The electronic data generated by the virtual person corresponds to, for example, contents data including document data such as an experience note or a diary.

The virtual-person management device 10 manages information about a virtual person anonymously used on a network. The user management device 20 manages information about an actual user who owns a virtual person. The user management device 20 is arranged for each management company. The management company ensures responsibility capacity of a virtual person who is used by a user managed by the user management device 20 owned by the management company. The user terminal 30 is used by a user who owns a virtual person. The service providing device 40 provides the user terminal 30 with various types of services on the network. A service provided to the user terminal 30 corresponds to, for example, shopping on a network, a bulletin board, or an intermediary service for transaction of various types of electronic data. A service provided by the service providing device 40 can be used by both an actual person and a virtual person.

A functional configuration of the virtual-person management device 10 according to the first embodiment will be explained below with reference to FIG. 2. FIG. 2 is a functional block diagram of the virtual-person management device 10 according to the first embodiment. As depicted in FIG. 2, the virtual-person management device 10 includes a control unit 11 that totally controls the virtual-person management device 10 and a storage unit 12 in which a program used for an operation performed by the control unit 11, various types of data such as a virtual-person information file 121, and the like, are stored.

The control unit 11 includes a virtual-person information management unit 111, a receiving unit 112, an electronic-signature generating unit 113, and a transmitting unit 114.

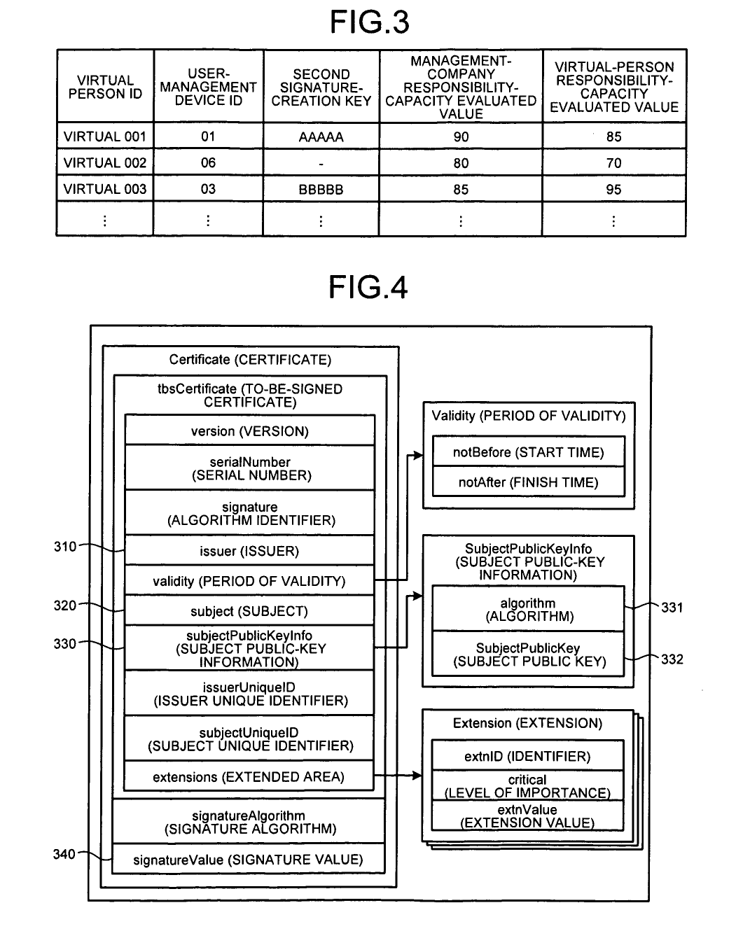

The virtual-person information management unit 111 manages virtual person information stored in the virtual-person information file 121. Data formation of the virtual-person information file 121 will be explained below with reference to FIG. 3. FIG. 3 is a diagram of the data formation of the virtual-person information file 121. The virtual-person information file 121 contains, for example, a virtual person identification (ID), a user-management device ID, a second signature-creation key, a management-company responsibility-capacity evaluated value, and a virtual-person responsibility-capacity evaluated value as data items. An ID for uniquely identifying a virtual person is stored in the virtual person ID. An ID for uniquely identifying a user management device that manages information about a user who owns a virtual person is stored in the user-management device ID.

A public key used for a third person to authenticate electronic data provided to the service providing device 40 by a virtual person is stored in the second signature-creation key contained in the virtual-person information file 121. Although a public-key encryption method is employed as an encryption method used for generating a second electronic signature that will be explained later in the first embodiment, the encryption method is not limited to the public-key encryption method. A common-key encryption method (secret-key encryption method) can be employed as the encryption method. An explanation will be given for an example in which the common-key encryption method is employed as the encryption method for generating the second electronic signature in a second embodiment of the present invention.

A management-company responsibility-capacity evaluated value for evaluating a level of a responsibility capacity of a management company of the user management device 20 is stored in the management-company responsibility-capacity evaluated value contained in the virtual-person information file 121. A virtual-person responsibility-capacity evaluated value for evaluating a level of a responsibility capacity of a virtual person is stored in the virtual-person responsibility-capacity evaluated value contained in the virtual-person information file 121.

The virtual-person information management unit 111 depicted in FIG. 2 creates the second signature-creation key (secret key) and a second signature-authentication key (public key) as a pair of keys used for an electronic signature of electronic data provided by a virtual person, and stores the second signature-creation key out of the pair of the generated keys in the second signature-creation key contained in the virtual-person information file 121.

The virtual-person information management unit 111 makes an electronic-certificate issue request to request the predetermined authentication organization to issue an electronic certificate used for the user terminal 30 of a third person that has acquired electronic data from the service providing device 40 to perform an operation (a second authentication operation) of authenticating the electronic data. The electronic-certificate issue request contains the virtual person ID and the second signature-authentication key. The electronic certificate certifies that information (the virtual person ID) for identifying the virtual person and the second signature-authentication key belong to the virtual person. In the specification, the electronic certificate is referred to as “virtual-person electronic certificate”.

A format example of the virtual-person electronic certificate is depicted in FIG. 4. The format example of the virtual-person electronic certificate depicted in FIG. 4 is a standard format of a public-key certificate in conformity to the X.509 Version 3 defined by the International Telecommunication Union Telecommunication (ITU-T). As depicted in FIG. 4, the virtual-person electronic certificate contains items such as a version, a serial number, an algorithm identifier, an issuer 310, a period of validity including a start time and a finish time, a subject 320, an subject public-key information 330 including an algorithm 331 and a subject public key 332, an issuer unique identifier, a subject unique identifier, an extended area, a signature algorithm, and a signature value 340. Main items are indicated with reference numerals in FIG. 4.

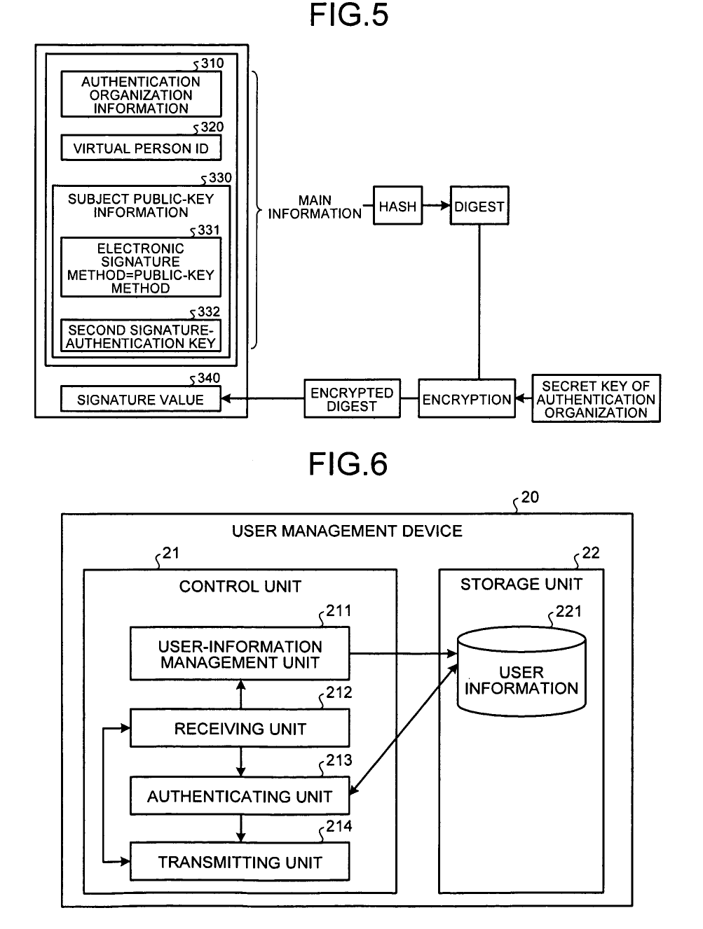

Information set in the main items contained in the virtual-person electronic certificate will be explained below with reference to FIG. 5. FIG. 5 is a diagram for explaining the information set in the main items contained in the virtual-person electronic certificate. As depicted in FIG. 5, authentication organization information is set in the issuer 310.

The virtual person ID is set in the subject 320. If the virtual person ID is prevented from being disclosed to a third person, it is possible that the virtual-person management device 10 issues a code for identifying the virtual person ID in association with the virtual person ID and transmits the electronic-certificate issue request including the code and the second signature-authentication key to the authentication organization. In such a case, the virtual-person management device 10 stores the issued code in the virtual-person information file 121 in association with the virtual person ID, and the authentication organization issues the virtual-person electronic certificate in which the code contained in the electronic-certificate issue request is set in the subject 320.

Information indicating that the second authentication operation is to be performed by the public-key encryption method or the common-key encryption method is set in the algorithm 331 included in the subject public-key information 330. Because the public-key encryption method is employed as the encryption method used for generating the second electronic signature in an example of the virtual-person electronic certificate depicted in FIG. 5, information indicating that the second authentication operation is to be performed by the public-key encryption method is set in the algorithm 331. The second signature-authentication key is set in the subject public key 332 included in the subject public-key information 330.

An encrypted digest generated based on main information including information containing the authentication organization information, the virtual person ID, and the subject public-key information 330 is set in the signature value 340. The encrypted digest is generated by the authentication organization. Specifically, the authentication organization hashes the main information by using a hash function thereby generating a digest, and encrypts the generated digest with a secret key of the authentication organization thereby generating an encrypted digest. After acquiring the virtual-person electronic certificate, the user terminal 30 of the third person authenticates the virtual-person electronic certificate by using the main information and the encrypted digest set in the signature value 340. Specifically, the user terminal 30 of the third person hashes the main information contained in the virtual-person electronic certificate by using the hash function thereby generating a digest, and decrypts the encrypted digest set in the signature value 340 with a public key of the authentication organization thereby generating a digest. The user terminal 30 of the third person then checks the two digests. If the digests are identical to each other, the user terminal 30 determines that the virtual-person electronic certificate is authentic, and if the digests are not identical to each other, the user terminal 30 determines that the virtual-person electronic certificate is not authentic.

The virtual-person information management unit 111 calculates the management-company responsibility-capacity evaluated value and stores the calculated management-company responsibility-capacity evaluated value in the management-company responsibility-capacity evaluated value contained in the virtual-person information file 121. Specifically, for example, the virtual-person information management unit 111 expresses credibility based on log data about transaction in the past, a capacity for taking on a duty based on data about a current financial ability, or the like, continuity based on data indicating possibility of bankruptcy or a takeover in the future, or the like, in a numeric value by using a predetermined method and assigns the numeric value to a predetermined evaluation calculation formula thereby calculating the management-company responsibility-capacity evaluated value. Moreover, the virtual-person information management unit 111 calculates the virtual-person responsibility-capacity evaluated value and stores the calculated virtual-person responsibility-capacity evaluated value in the virtual-person responsibility-capacity evaluated value contained in the virtual-person information file 121. Specifically, for example, the virtual-person information management unit 111 expresses credibility based on log data about transaction in the past, or the like, in a numeric value by using a predetermined method and assigns the numeric value to a predetermined evaluation calculation formula thereby calculating the virtual-person responsibility-capacity evaluated value. However, if the virtual person is initially registered, because no actual performance of transaction has been made by the virtual person, the virtual-person information management unit 111 temporarily calculates the virtual-person responsibility-capacity evaluated value by, for example, assigning the management-company responsibility-capacity evaluated value and a user responsibility-capacity evaluated value that will be explained later to a predetermined evaluation calculation formula.

The receiving unit 112 receives various types of information from the user management device 20 and the user terminal 30. The information received from the user management device 20 includes, for example, an issue instruction for instructing issue of the virtual person ID, a first signature-creation key issue notification to notify that a first signature-creation key has been issued to the virtual person, and a first authentication notification to notify that the electronic data has been authenticated by using a first signature-authentication key. The first signature-creation key corresponds to a secret key issued by the user management device 20 for a user who owns a virtual person, and the first signature-authentication key corresponds to a public key used for the user management device 20 to authenticate the electronic data.

The information received from the user terminal 30 includes, for example, a second electronic-signature generation request for requesting generation of the second electronic signature for the virtual person. The second electronic-signature generation request includes electronic data provided by the virtual person, a first electronic signature, and the virtual person ID. The first electronic signature is generated by the user terminal 30. Specifically, the user terminal 30 hashes the electronic data provided by the virtual person by using the hash function thereby generating a digest. The user terminal 30 then encrypts the generated digest with the first signature-creation key thereby generating an encrypted digest. The encrypted digest corresponds to “first electronic signature”.

Upon receiving the first authentication notification notifying that the electronic data has been authenticated by using the first signature-authentication key, the electronic-signature generating unit 113 generates the second electronic signature. Specifically, the electronic-signature generating unit 113 hashes the electronic data received from the user terminal 30 by using the hash function thereby generating a digest. The electronic-signature generating unit 113 then acquires, by using the virtual person ID received from the user terminal 30, the second signature-creation key that is stored in association with the virtual person ID from the virtual-person information file 121. The electronic-signature generating unit 113 then encrypts the generated digest with the second signature-creation key thereby generating an encrypted digest. The encrypted digest corresponds to “second electronic signature”.

The transmitting unit 114 transmits various types of information to the user management device 20 and the user terminal 30. The information transmitted to the user management device 20 includes, for example, a newly issued virtual person ID and a first authentication request notification for requesting authentication of electronic data received from the user terminal 30. The first authentication request notification includes the electronic data, the first electronic signature, and the virtual person ID. The information transmitted to the user terminal 30 includes, for example, the second electronic signature and the virtual-person electronic certificate.

A functional configuration of the user management device 20 according to the first embodiment will be explained below with reference to FIG. 6. FIG. 6 is a functional block diagram of the user management device 20 according to the first embodiment. As depicted in FIG. 6, the user management device 20 includes a control unit 21 that totally controls the user management device 20 and a storage unit 22 in which a program used for an operation performed by the control unit 21 and various types of data such as a user information file 221 are stored.

The control unit 21 includes a user-information management unit 211, a receiving unit 212, an authenticating unit 213, and a transmitting unit 214.

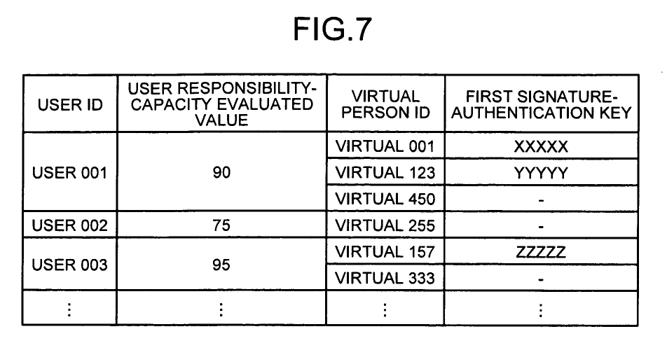

The user-information management unit 211 manages user information stored in the user information file 221. Data formation of the user information file 221 will be explained below with reference to FIG. 7. FIG. 7 is a diagram of the data formation of the user information file 221. The user information file 221 contains, for example, a user ID, a user responsibility-capacity evaluated value, the virtual person ID, and the first signature-authentication key as data items. An ID for uniquely identifying a user is stored in the user ID. A user responsibility-capacity evaluated value for evaluating a level of a responsibility capacity of the user is stored in the user responsibility-capacity evaluated value. An ID for uniquely identifying a virtual person owned by the user is stored in the virtual person ID. A public key used for the authenticating unit 213 included in the user management device 20 to authenticate electronic data provided to the virtual-person management device 10 by the virtual person is stored in the first signature-authentication key. Although the public-key encryption method is employed as the encryption method used for generating the first electronic signature in the first embodiment, the encryption method is not limited to the public-key encryption method. The common-key encryption method can be employed as the encryption method. If the common-key encryption method is employed, a first secret key is stored in the user information file 221 instead of the first signature-authentication key. The first secret key stored in the user information file 221 is used when an administrator of the user management device 20 authenticates the electronic data provided to the service providing device 40 by the virtual person.

The user-information management unit 211 depicted in FIG. 6 stores the virtual person ID received from the virtual-person management device 10 in the virtual person ID contained in the user information file 221. The user-information management unit 211 creates the first signature-creation key (secret key) and the first signature-authentication key (public key) as a pair of keys used for an electronic signature for a user who owns a virtual person, and stores the first signature-authentication key out of the pair of the generated keys in the first signature-authentication key contained in the user information file 221.

The user-information management unit 211 calculates the user responsibility-capacity evaluated value and stores the calculated user responsibility-capacity evaluated value in the user responsibility-capacity evaluated value contained in the user information file 221. Specifically, the user-information management unit 211 acquires credibility information managed by a credit company, expresses the credibility information in a numeric value by using a predetermined method, and assigns the numeric value to a predetermined evaluation calculation formula thereby calculating the user responsibility-capacity evaluated value.

The receiving unit 212 receives various types of information from the virtual-person management device 10 and the user terminal 30. The information received from the virtual-person management device 10 includes, for example, a newly issued virtual person ID and the first authentication request notification. The information received from the user terminal 30 includes, for example, an issue request for requesting issue of the virtual person ID and an issue request for requesting issue of the first signature-creation key.

The authenticating unit 213 performs a first authentication operation to authenticate the electronic data included in the first authentication request notification received from the virtual-person management device 10 and the virtual person who has provided the electronic data. Specifically, the authenticating unit 213 hashes the electronic data included in the first authentication request notification by using the hash function thereby generating a digest. The authenticating unit 213 then acquires, by using the virtual person ID included in the first authentication request notification, the first signature-authentication key that is stored in association with the virtual person ID from the user information file 221. The authenticating unit 213 then decrypts the encrypted digest included in the first authentication request notification by using the acquired first signature-authentication key thereby generating a digest. The authenticating unit 213 checks the two generated digests. If the digests are identical to each other, the authenticating unit 213 certifies that the electronic data and the virtual person who has provided the electronic data are authentic.

The transmitting unit 214 transmits various types of information to the virtual-person management device 10 and the user terminal 30. The information transmitted to the virtual-person management device 10 includes, for example, an issue instruction for instructing issue of the virtual person ID, the first signature-creation key issue notification notifying that the first signature-creation key has been issued to the virtual person, and the first authentication notification notifying that the electronic data has been authenticated. The information transmitted to the user terminal 30 includes, for example, a newly issued virtual person ID and the first signature-creation key.

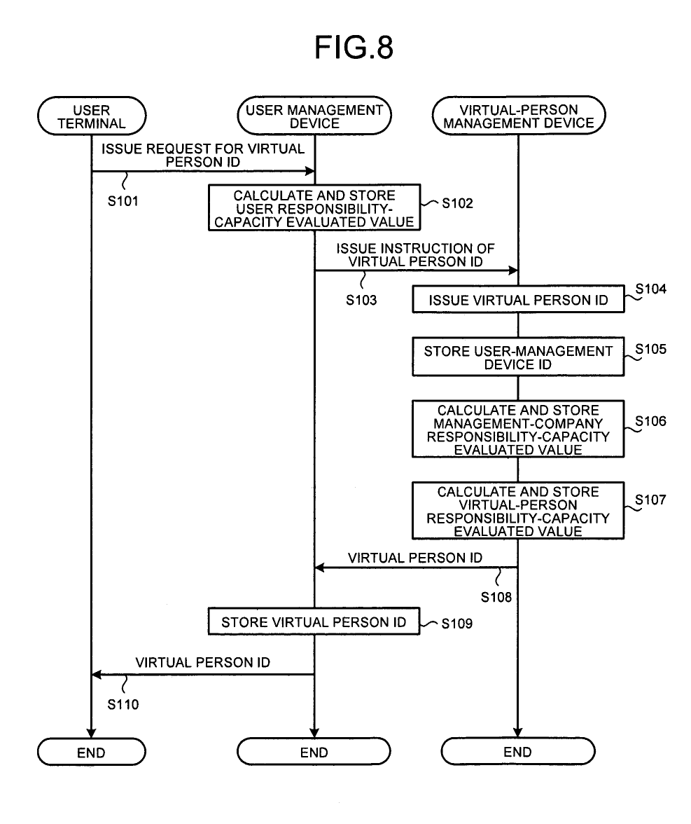

An explanation will be given for an operation performed when a user acquires the virtual person ID on the premise of usage of the virtual-person management system 1 with reference to FIG. 8. FIG. 8 is a sequence chart for explaining an operation performed when the virtual person ID is issued. Specifically, an explanation will be given for an operation performed when the user terminal 30 accesses the user management device 20 that manages a user of the user terminal 30 and acquires the virtual person ID issued by the virtual-person management device 10 via the user management device 20.

First, the user terminal 30 transmits an issue request for requesting issue of the virtual person ID to the user management device 20 (Step S101).

The user-information management unit 211 included in the user management device 20 then calculates the user responsibility-capacity evaluated value and stores the calculated user responsibility-capacity evaluated value in the user responsibility-capacity evaluated value contained in the user information file 221 (Step S102).

The transmitting unit 214 included in the user management device 20 then transmits an issue instruction for instructing issue of the virtual person ID to the virtual-person management device 10 (Step S103).

The virtual-person information management unit 111 included in the virtual-person management device 10 then issues the virtual person ID (Step S104) and generates virtual person information. The virtual-person information management unit 111 stores the user-management device ID of the user management device 20 that has transmitted the issue instruction at Step S103 in the user-management device ID contained in the virtual person information (Step S105). The virtual-person information management unit 111 calculates the management-company responsibility-capacity evaluated value and stores the calculated management-company responsibility-capacity evaluated value in the management-company responsibility-capacity evaluated value contained in the virtual person information (Step S106). The virtual-person information management unit 111 then calculates the virtual-person responsibility-capacity evaluated value and stores the calculated virtual-person responsibility-capacity evaluated value in the virtual-person responsibility-capacity evaluated value contained in the virtual person information (Step S107).

The transmitting unit 114 included in the virtual-person management device 10 then transmits the virtual person ID issued at Step S104 to the user management device 20 (Step S108).

The user-information management unit 211 included in the user management device 20 then stores the virtual person ID received from the virtual-person management device 10 in the virtual person ID contained in the user information file 221 (Step S109). The transmitting unit 214 included in the user management device 20 transmits the virtual person ID to the user terminal 30 (Step S110). Thus, the user can acquire the virtual person ID and operate as the virtual person on the network.

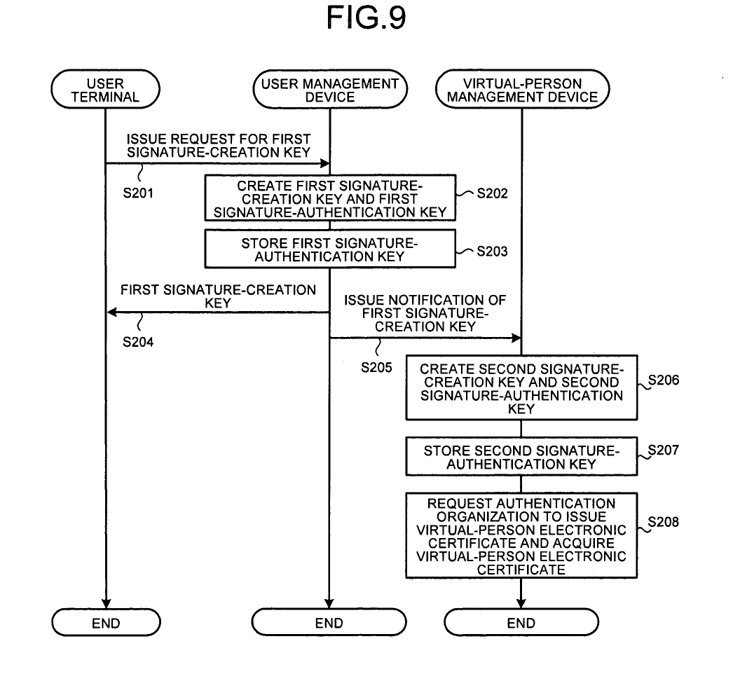

A key creation operation performed by the virtual-person management device 10 and the user management device 20 will be explained below with reference to FIG. 9. FIG. 9 is a sequence chart for explaining the key creation operation performed by the virtual-person management device 10 and the user management device 20. Specifically, an explanation will be given for an operation performed when the user terminal 30 causes the user management device 20 that manages the user of the user terminal 30 to create the first signature-creation key and the first signature-authentication key and the user management device 20 causes the virtual-person management device 10 to create the second signature-creation key and the second signature-authentication key.

First, the user terminal 30 accesses the user management device 20 to request issue of the first signature-creation key (Step S201).

The user-information management unit 211 included in the user management device 20 creates the first signature-creation key and the first signature-authentication key (Step S202) and stores the created first signature-authentication key in the first signature-authentication key contained in the user information file 221 (Step S203).

The transmitting unit 214 included in the user management device 20 then transmits the created first signature-creation key to the user terminal 30 (Step S204). Thus, the user terminal 30 can generate the first electronic signature from the electronic data by using the first signature-creation key received from the user management device 20.

The transmitting unit 214 included in the user management device 20 then transmits the first signature-creation key issue notification notifying that the first signature-creation key has been issued to the virtual-person management device 10 (Step S205).

The virtual-person information management unit 111 included in the virtual-person management device 10 then creates the second signature-creation key and the second signature-authentication key used for generating an electronic signature of the electronic data provided by the virtual person (Step S206) and stores the created second signature-creation key in the second signature-creation key contained in the virtual-person information file 121 (Step S207).

The virtual-person information management unit 111 included in the virtual-person management device 10 requests the predetermined authentication organization to issue the virtual-person electronic certificate corresponding to the second signature-authentication key and then acquires the virtual-person electronic certificate from the authentication organization (Step S208).

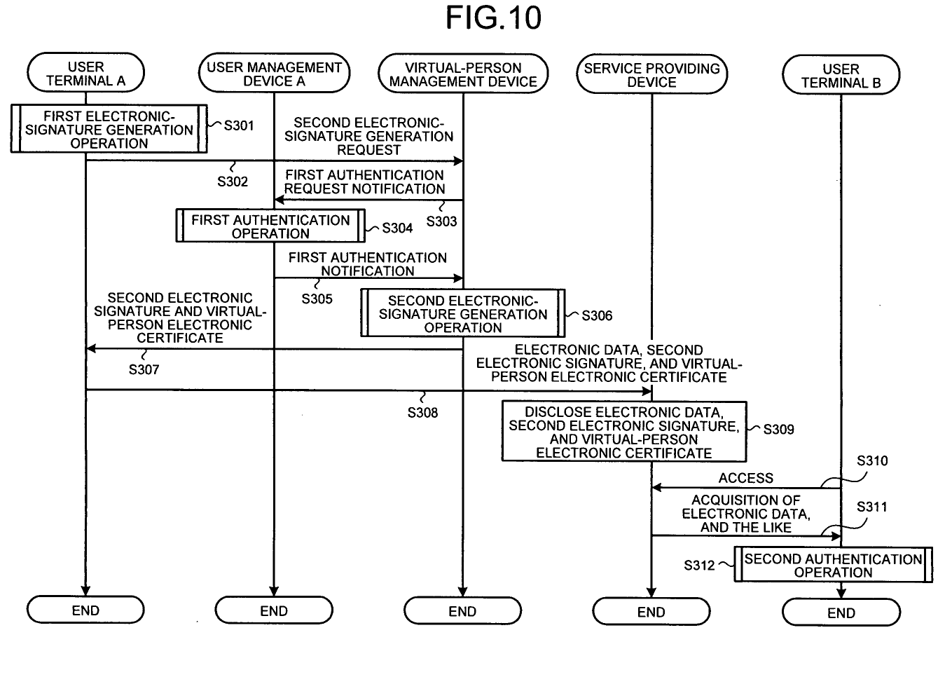

An explanation will be given for an operation performed from when the user terminal 30 provides the virtual-person management device 10 with the electronic data to when a third person acquires the electronic data and authenticates the acquired electronic data with reference to FIG. 10. FIG. 10 is a sequence chart for explaining an example of an operation performed when the electronic data is authenticated. Specifically, an explanation will be given for an operation performed when a user of a user terminal B acquires the electronic data provided to the service providing device 40 by the virtual person who is a user of the user terminal A. In this operation, the user terminal 30 used by a user A who has provided the electronic data is referred to as the user terminal A, and the user terminal 30 used by a user B who has acquired the electronic data is referred to as the user terminal B. The user management device 20 that manages information about the user A is referred to as a user management device A.

First, the user terminal A performs a first electronic-signature generation operation to generate the first electronic signature from the electronic data provided by the virtual person (Step S301). The first electronic-signature generation operation performed by the user terminal A will be explained in detail later.

The user terminal A transmits the second electronic-signature generation request including the electronic data provided by the virtual person, the generated first electronic signature, and the virtual person ID to the virtual-person management device 10 (Step S302).

The transmitting unit 114 included in the virtual-person management device 10 then transmits the first authentication request notification for requesting authentication of the electronic data received from the user terminal A to the user management device A (Step S303).

The authenticating unit 213 included in the user management device A then performs the first authentication operation to authenticate the electronic data included in the authentication request notification and the virtual person who has provided the electronic data (Step S304). If the electronic data and the virtual person are authentic, the transmitting unit 214 included in the user management device A transmits the first authentication notification indicating that the electronic data is authentic to the virtual-person management device 10 (Step S305). The first authentication operation performed by the user management device A will be explained in detail later.

The electronic-signature generating unit 113 included in the virtual-person management device 10 then performs a second electronic-signature generation operation to generate the second electronic signature from the electronic data received from the user terminal A (Step S306). The transmitting unit 114 included in the virtual-person management device 10 transmits the generated second electronic signature and the virtual-person electronic certificate to the user terminal A (Step S307). The second electronic-signature generation operation performed by the virtual-person management device 10 will be explained in detail later.

The user terminal A then transmits the electronic data, the second electronic signature, and the virtual-person electronic certificate to the service providing device 40 (Step S308). The service providing device 40 discloses the electronic data, the second electronic signature, and the virtual-person electronic certificate received from the user terminal A on an intermediary site for transaction of electronic data (Step S309).

The user terminal B accesses the intermediary site for transaction (the service providing device 40) (Step S310) and then acquires the electronic data provided by the virtual person of the user A, the second electronic signature, and the virtual-person electronic certificate (Step S311). The user terminal B then performs the second authentication operation (Step S312) thereby authenticating the acquired electronic data. The second authentication operation performed by the user terminal B will be explained in detail later.

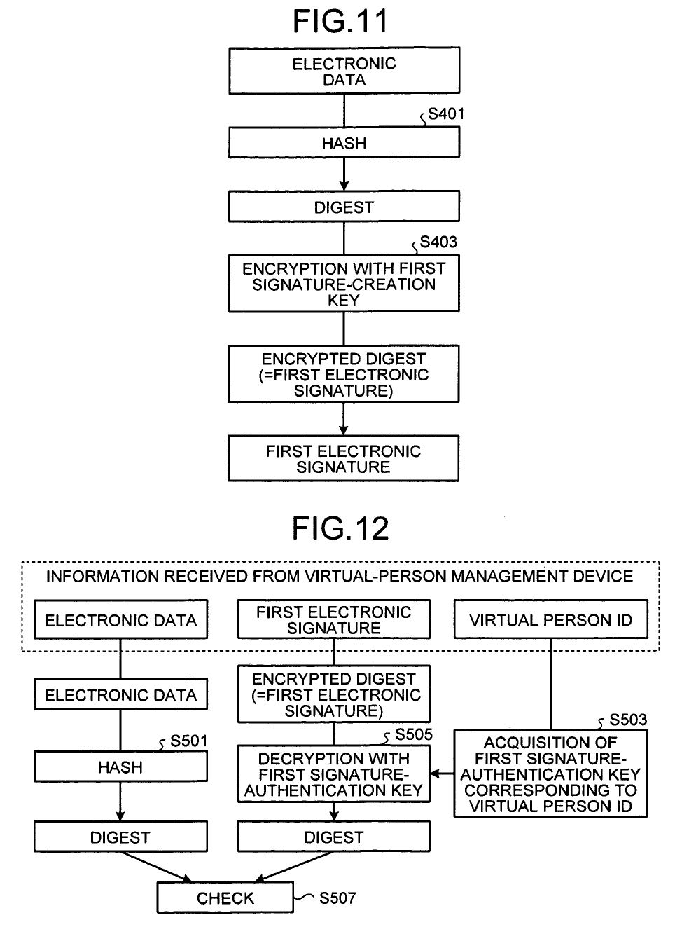

The first electronic-signature generation operation performed by the user terminal A as depicted in FIG. 10 will be explained below with reference to FIG. 11. FIG. 11 is a schematic diagram for explaining the first electronic-signature generation operation performed by the user terminal A as represented in FIG. 10.

As depicted in FIG. 11, the user terminal A hashes the electronic data provided by the virtual person by using the hash function thereby generating a digest (Step S401). The user terminal A then encrypts the digest with the first signature-creation key thereby generating an encrypted digest (Step S403). The encrypted digest corresponds to “first electronic signature”.

The first authentication operation performed by the user management device A as depicted in FIG. 10 will be explained below with reference to FIG. 12. FIG. 12 is a schematic diagram for explaining the first authentication operation performed by the user management device A as represented in FIG. 10.

As depicted in FIG. 12, the authenticating unit 213 included in the user management device A hashes the electronic data included in the first authentication request notification received from the virtual-person management device 10 by using the hash function thereby generating a digest (Step S501). The authenticating unit 213 included in the user management device A then extracts, by using the virtual person ID included in the first authentication request notification received from the virtual-person management device 10, the first signature-authentication key that is stored in association with the virtual person ID from the user information file 221 thereby acquiring the first signature-authentication key (Step S503). The authenticating unit 213 included in the user management device A then decrypts the first electronic signature (the encrypted digest) included in the first authentication request notification received from the virtual-person management device 10 with the first signature-authentication key thereby generating a digest (Step S505).

The authenticating unit 213 included in the user management device A checks the digest generated at Step S501 against the digest generated at Step S505 (Step S507). If the two digests are identical to each other, the authenticating unit 213 certifies that the electronic data and the virtual person who has provided the electronic data are authentic.

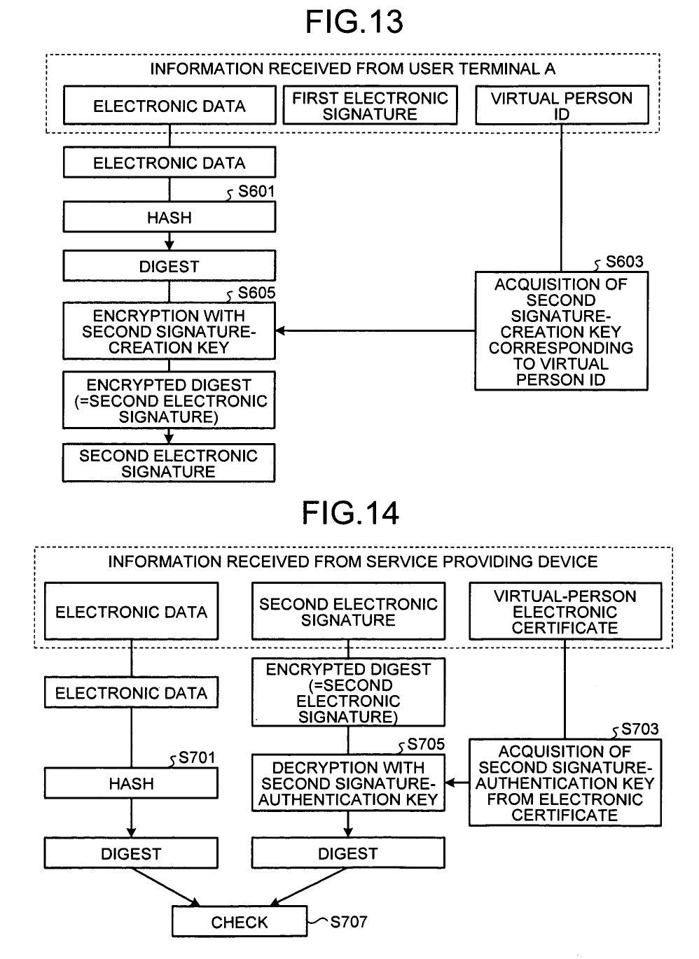

The second electronic-signature generation operation performed by the virtual-person management device 10 as depicted in FIG. 10 will be explained below with reference to FIG. 13. FIG. 13 is a schematic diagram for explaining the second electronic-signature generation operation performed by the virtual-person management device 10 as represented in FIG. 10.

As depicted in FIG. 13, the electronic-signature generating unit 113 included in the virtual-person management device 10 hashes the electronic data received from the user terminal A by using the hash function thereby generating a digest (Step S601).

The electronic-signature generating unit 113 included in the virtual-person management device 10 then extracts, by using the virtual person ID received from the user terminal A, the second signature-creation key that is stored in association with the virtual person ID from the virtual-person information file 121 thereby acquiring the second signature-creation key (Step S603).

The electronic-signature generating unit 113 included in the virtual-person management device 10 then encrypts the digest generated at Step S601 with the second signature-creation key thereby generating an encrypted digest (Step S605).

The second authentication operation performed by the user terminal B as depicted in FIG. 10 will be explained below with reference to FIG. 14. FIG. 14 is a schematic diagram for explaining the second authentication operation performed by the user terminal B as represented in FIG. 10.

As depicted in FIG. 14, the user terminal B hashes the electronic data acquired from the intermediary site for transaction (the service providing device 40) by using the hash function thereby generating a digest (Step S701). The user terminal B then acquires the second signature-authentication key from the virtual-person electronic certificate issued at Step S208 (see FIG. 9) (Step S703). The user terminal B then decrypts the second electronic signature (the encrypted digest) acquired from the intermediary site for transaction with the second signature-authentication key thereby generating a digest (Step S705).

The user terminal B then checks the digest generated at Step S701 against the digest generated at Step S705 (Step S707). If the two digest are identical to each other, it is certified that the virtual-person electronic certificate acquired from the intermediary site for transaction is authentic and that the electronic data acquired from the intermediary site for transaction is provided by the virtual person corresponding to the virtual person ID included in the virtual-person electronic certificate.

As described above, in the virtual-person management system 1 according to the first embodiment, it is possible to authenticate the electronic data for the third person who has acquired the electronic data provided by the virtual person by using the second signature-authentication key corresponding to the second signature-creation key issued by the virtual-person management device 10 for the virtual person, so that the first signature-authentication key corresponding to the first signature-creation key used by the virtual person can be concealed from the third person. Therefore, it is possible to authenticate the electronic data provided by the virtual person anonymously used on the network while ensuring anonymity of the virtual person.

Although it is explained in the first embodiment that devices managed by the management company are separately arranged as the virtual-person management device 10 and the user management device 20, the configuration of the devices managed by the management company is not limited to the above. For example, functions included in the virtual-person management device 10 and the user management device 20 can be combined in one management device or separately arranged in a larger number of management devices. That is, any configuration can be employed as long as the present invention can be implemented as one virtual-person management system.

Furthermore, although it is explained in the first embodiment that the virtual-person management device 10 and the authentication organization that issues the electronic certificate are separately arranged, functions included in the virtual-person management device 10 can be combined in the authentication organization.

Moreover, although it is explained in the first embodiment that the second signature-authentication key is created for each virtual person, the present invention is not limited to such a configuration. For example, it is possible that a second signature-authentication key shared by all virtual persons is created and the second electronic signature is generated by using the second signature-authentication key.

Furthermore, although it is explained in the first embodiment that, as depicted in FIG. 10, the user terminal A transmits the second electronic-signature generation request to the virtual-person management device 10 (Step S302), and after the virtual-person management device 10 generates the second electronic signature (Step S306), the virtual-person management device 10 transmits the second electronic signature, and the like, to the user terminal A (Step S307) and the user terminal A transmits the second electronic signature, and the like, to the service providing device 40 (Step S308), the present invention is not limited to such a configuration. For example, it is possible that the user terminal A transmits the electronic data, and the like, to the service providing device 40 and the service providing device 40 that has received the electronic data, and the like, transmits the second electronic-signature generation request to the virtual-person management device 10.

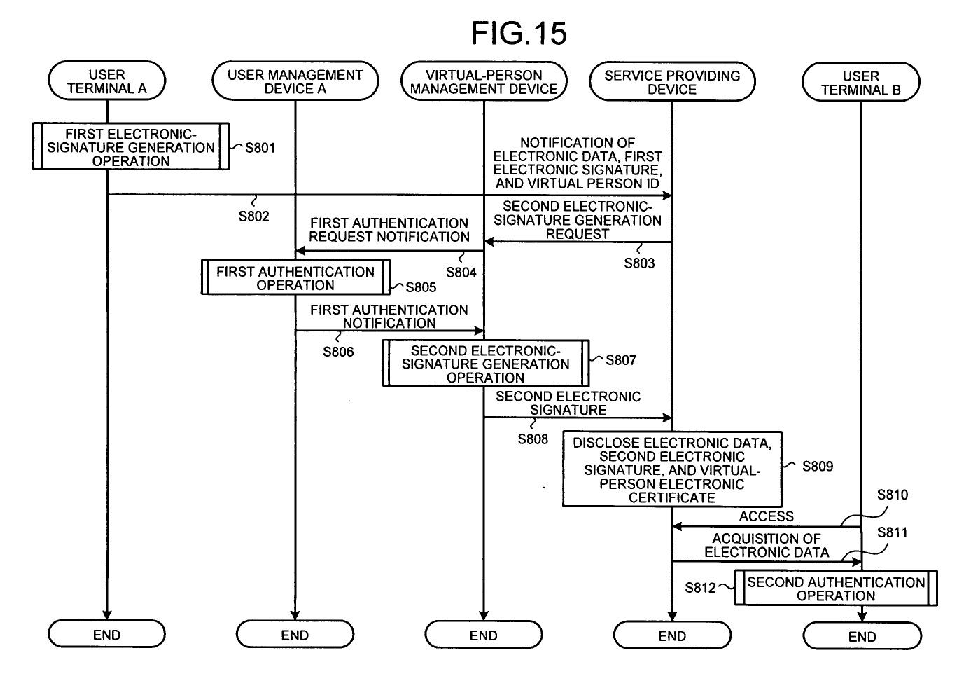

An explanation will be given for another example of the operation performed from when the user terminal 30 provides the virtual-person management device 10 with the electronic data to when the third person acquires the electronic data and authenticates the acquired electronic data with reference to FIG. 15. FIG. 15 is a sequence chart for explaining an example of the operation performed when the electronic data is authenticated.

As depicted in FIG. 15, the user terminal A performs the first electronic-signature generation operation (Step S801). The user terminal A transmits the electronic data provided by the virtual person, the generated first electronic signature, and the virtual person ID to the service providing device 40 (Step S802).

The service providing device 40 then transmits the second electronic-signature generation request including the electronic data, the first electronic signature, and the virtual person ID received from the user terminal A to the virtual-person management device 10 (Step S803).

The transmitting unit 114 included in the virtual-person management device 10 then transmits the first authentication request notification to request authentication of the electronic data received from the service providing device 40 to the user management device A (Step S804).

The authenticating unit 213 included in the user management device A then performs the first authentication operation (Step S805), and if the electronic data is authentic, the transmitting unit 214 included in the user management device A transmits the first authentication notification indicating that the electronic data is authentic to the virtual-person management device 10 (Step S806).

The electronic-signature generating unit 113 included in the virtual-person management device 10 performs the second electronic-signature generation operation (Step S807). The transmitting unit 114 included in the virtual-person management device 10 transmits the generated second electronic signature and the virtual-person electronic certificate to the service providing device 40 (Step S808).

The service providing device 40 discloses the electronic data, the second electronic signature, and the virtual-person electronic certificate received from the virtual-person management device 10 on the intermediary site for transaction of electronic data (Step S809).

The user terminal B accesses the intermediary site for transaction (the service providing device 40) (Step S810) and then acquires the electronic data provided by the virtual person of the user A, the second electronic signature, and the virtual-person electronic certificate (Step S811). The user terminal B then performs the second authentication operation (Step S812) thereby authenticating the acquired electronic signature.

The configuration of the virtual-person management device 10 according to the first embodiment as depicted in FIG. 2 and the configuration of the user management device 20 according to the first embodiment as depicted in FIG. 4 can be modified in various manners without departing from the scope of the present invention. For example, it is possible that functions of the control unit 11 included in the virtual-person management device 10 and/or the control unit 21 included in the user management device 20 are implemented as software and executed by a computer so that functions similar to those of the virtual-person management device 10 and/or the user management device 20 are achieved. In the following description, an explanation will be given for an example of a computer 1000 that executes an electronic-data authentication program 1071 in which the functions of the control unit 11 and/or the control unit 21 are implemented as software.

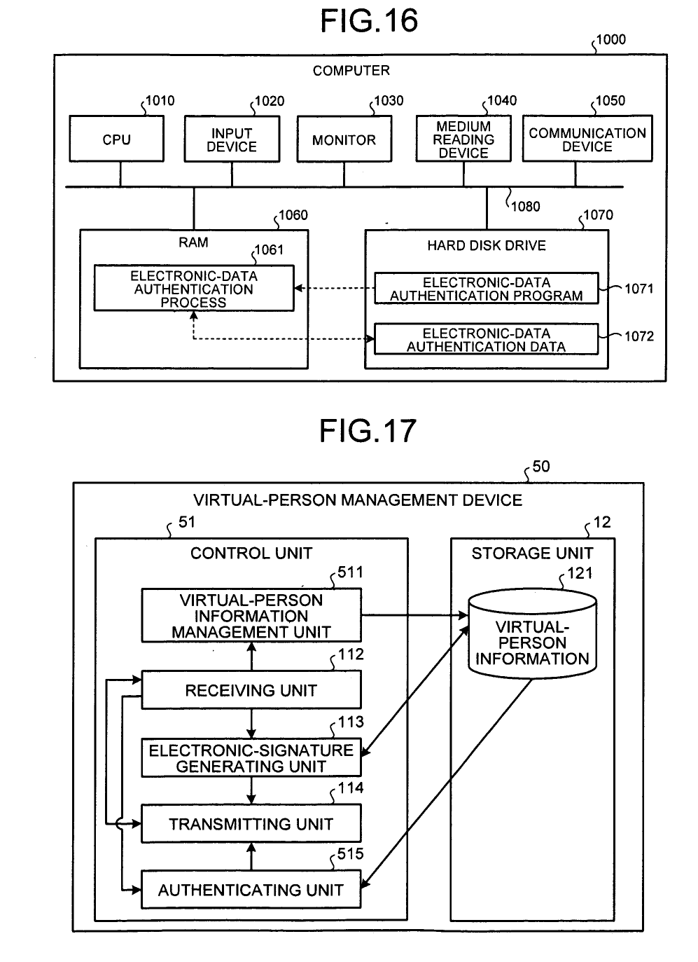

FIG. 16 is a block diagram of the computer 1000 that executes the electronic-data authentication program 1071. The computer 1000 includes a central processing unit (CPU) 1010 that executes various types of arithmetic processing, an input device 1020 that receives data input from a user, a monitor 1030 that displays various types of information, a medium reading device 1040 that reads a program, or the like, from a storage medium, a communication device 1050 that transmits and receives data to and from a different computer via a network, a random access memory (RAM) 1060 in which various types of information is temporarily stored, and a hard disk drive 1070. The CPU 1010, the input device 1020, the monitor 1030, the medium reading device 1040, the communication device 1050, the RAM 1060, and the hard disk drive 1070 are connected to one another via a bus 1080.

The hard disk drive 1070 stores therein the electronic-data authentication program 1071 having functions similar to those of the control unit 11 depicted in FIG. 2 and/or the control unit 21 depicted in FIG. 6 and electronic-data authentication data 1072 corresponding to various types of data stored in the storage unit 12 depicted in FIG. 2 and/or the storage unit 22 depicted in FIG. 6. It is possible that the electronic-data authentication data 1072 is distributed as appropriate and stored in a different computer connected to the computer 1000 via a network.

The CPU 1010 reads the electronic-data authentication program 1071 from the hard disk drive 1070 and expands the read electronic-data authentication program 1071 on the RAM 1060, so that the electronic-data authentication program 1071 functions as an electronic-data authentication process 1061. The electronic-data authentication process 1061 expands data, or the like, read from the electronic-data authentication data 1072 on an area of the RAM 1060 that is allocated to the electronic-data authentication process 1061 as appropriate and executes various types of data processing based on the expanded data.

The electronic-data authentication program 1071 does not always need to be stored in the hard disk drive 1070. It is possible that the electronic-data authentication program 1071 stored in a storage medium such as a compact disc read only memory (CD-ROM) is read by the computer 1000 and the read electronic-data authentication program 1071 is executed by the computer 1000. Alternatively, it is possible that the electronic-data authentication program 1071 is stored in a different computer (or a server) connected to the computer 1000 via a public line, the Internet, a local area network (LAN), a wide area network (WAN), or the like, and is read from the different computer by the computer 1000, and the read electronic-data authentication program 1071 is executed by the computer 1000.

### Second Embodiment

Although it is explained in the first embodiment that the public-key encryption method using the second signature-creation key and the second signature-authentication key is employed as the authentication method performed between the service providing device 40 and the user terminal 30 (the user terminal B in the example depicted in FIG. 10) of the third person, the common-key encryption method can be employed instead. In the second embodiment, an explanation will be given for an example in which the common-key encryption method is employed as the authentication method performed between the service providing device 40 and the user terminal 30 of the third person.

A functional configuration of a virtual-person management device 50 according to the second embodiment will be explained below with reference to FIG. 17. FIG. 17 is a functional block diagram of the virtual-person management device 50 according to the second embodiment. As depicted in FIG. 17, a control unit 51 included in the virtual-person management device 50 is different from the control unit 11 depicted in FIG. 2 in that a virtual-person information management unit 511 included in the control unit 51 has a different function from that of the virtual-person information management unit 111 included in the control unit 11. Furthermore, the control unit 51 is different from the control unit 11 depicted in FIG. 2 in that the control unit 51 further includes an authenticating unit 515.

The virtual-person information management unit 511 creates a second signature common key (secret key) as a key used for an electronic signature of the electronic data provided by the virtual person and stores the created second signature common key in the second signature-creation key contained in the virtual-person information file 121.

When the receiving unit 112 receives a second authentication request notification from the user terminal 30 of the third person, the authenticating unit 515 performs the second authentication operation and a authentication-result notification information generation operation for generating authentication-result notification information to notify the user terminal 30 of a authentication result. Because the user terminal 30 of the third person may not acquire the second signature common key for performing the second authentication operation, the user terminal 30 requests the virtual-person management device 50 to perform the second authentication operation. The second authentication operation and the authentication-result notification information generation operation performed by the authenticating unit 515 will be explained in detail later.

The virtual-person information management unit 511 included in the virtual-person management device 50 creates a notification-information creation key (secret key) and a notification-information authentication key (public key) as a pair of keys used for an electronic signature of authentication-result notification information. Furthermore, the virtual-person information management unit 511 requests the predetermined authentication organization to issue an electronic certificate (hereinafter, referred to as “notification-information electronic certificate”) used for the user terminal 30 to authenticate the authentication-result notification information.

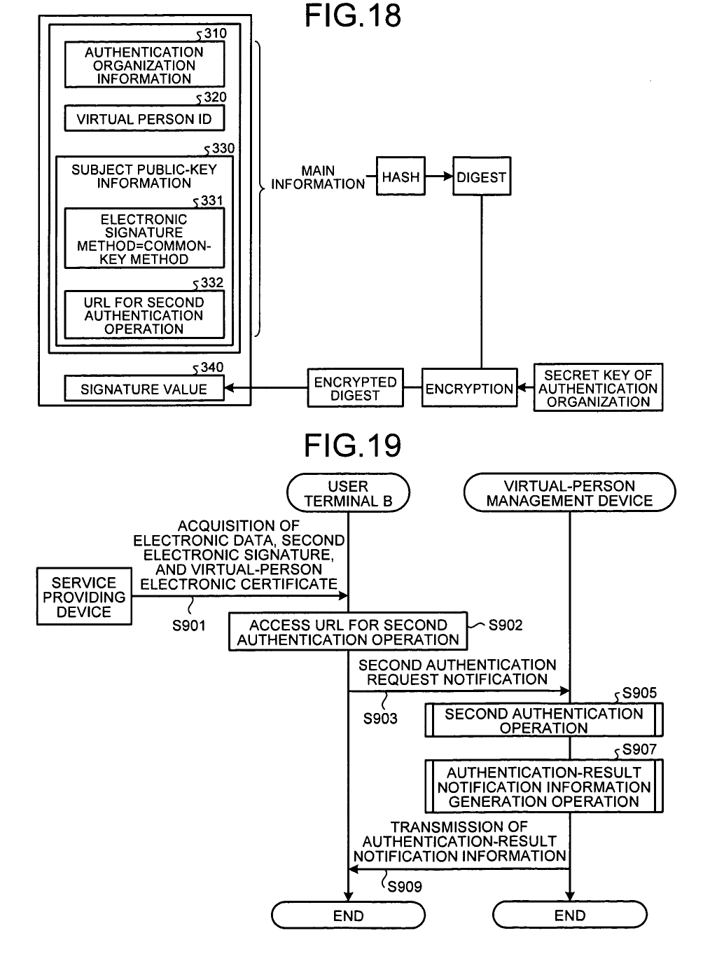

An explanation will be given for information set in main items contained in the virtual-person electronic certificate in a case where a common-key encryption method is employed as the encryption method for generating the second electronic signature with reference to FIG. 18. FIG. 18 is a diagram for explaining the information set in the main items contained in the virtual-person electronic certificate in the case of the common-key encryption method. The virtual-person electronic certificate used in the case of the common-key encryption method has the same format as that of the virtual-person electronic certificate depicted in FIG. 5. As depicted in FIG. 18, authentication organization information is set in the issuer 310 and the virtual person ID is set in the subject 320 in the same manner as in the example of the electronic certificate depicted in FIG. 5.

Information indicating the common-key encryption method is set in the algorithm 331 included in the subject public-key information 330. Because the second signature common key is not allowed to be made public, a Uniform Resource Locator (URL) for invoking the second authentication operation is set in the subject public key 332 included in the subject public-key information 330. When the third person accesses the URL, the authenticating unit 515 performs the second authentication operation and the authentication-result notification information generation operation.

An encrypted digest generated based on main information including information containing the authentication organization information, the virtual person ID, and the subject public-key information is set in the signature value 340. The encrypted digest is generated by the authentication organization. Specifically, the authentication organization hashes the main information by using the hash function to generate a digest and encrypts the generated digest with a secret key of the authentication organization thereby generating an encrypted digest.

An explanation will be given for the second authentication operation in a case where the common-key encryption method is employed as the encryption method used for generating the second electronic signature with reference to FIG. 19. FIG. 19 is a schematic diagram for explaining the second authentication operation in the case of the common-key encryption method.

As depicted in FIG. 19, the user terminal B of the third person accesses the service providing device 40 thereby acquiring the electronic data, the second electronic signature, and the virtual-person electronic certificate (Step S901).

The user terminal B accesses the URL to invoke the second authentication operation based on the virtual-person electronic certificate (Step S902) and performs the second authentication request notification to request the virtual-person management device 50 to perform the second authentication operation (Step S903).

The authenticating unit 515 included in the virtual-person management device 50 then performs the second authentication operation (Step S905) and performs the authentication-result notification information generation operation to generate the authentication-result notification information (Step S907). The authenticating unit 515 included in the virtual-person management device 50 transmits the authentication-result notification information to the user terminal B (Step S909).

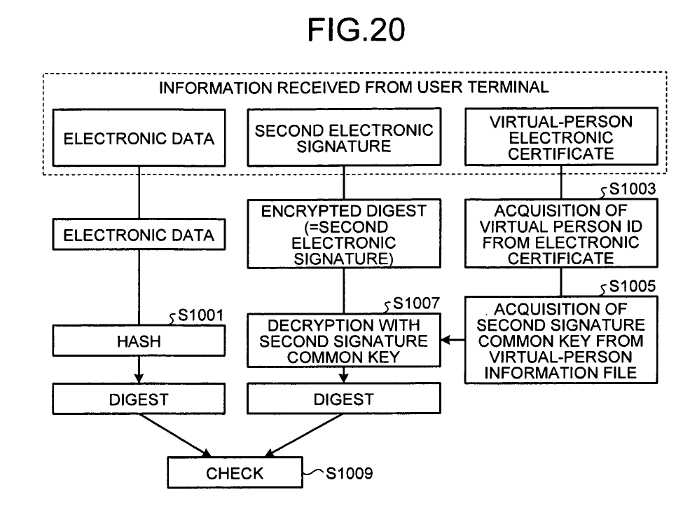

An explanation will be given for the second authentication operation performed by the virtual-person management device 50 as depicted in FIG. 19 with reference to FIG. 20. FIG. 20 is a schematic diagram for explaining the second authentication operation performed by the virtual-person management device 50 depicted in FIG. 19.

As depicted in FIG. 20, the authenticating unit 515 included in the virtual-person management device 50 hashes the electronic data included in the second authentication request notification received from the user terminal B by using the hash function thereby generating a digest (Step S1001). The authenticating unit 515 included in the virtual-person management device 50 then acquires the virtual person ID from the virtual-person electronic certificate included in the second authentication request notification (Step S1003). The authenticating unit 515 included in the virtual-person management device 50 then acquires the second signature common key that is stored in association with the virtual person ID from the virtual-person information file 121 (Step S1005). The authenticating unit 515 included in the virtual-person management device 50 then decrypts the second electronic signature included in the second authentication request notification with the second signature common key thereby generating a digest (Step S1007).

The authenticating unit 515 included in the virtual-person management device 50 checks the digest generated at Step S1001 against the digest generated at Step S1007 (Step S1009). If the two digests are identical to each other, it is certified that the virtual-person electronic certificate acquired from the intermediary site for transaction is authentic and that the electronic data acquired from the intermediary site for transaction is provided by the virtual person corresponding to the virtual person ID included in the virtual-person electronic certificate.

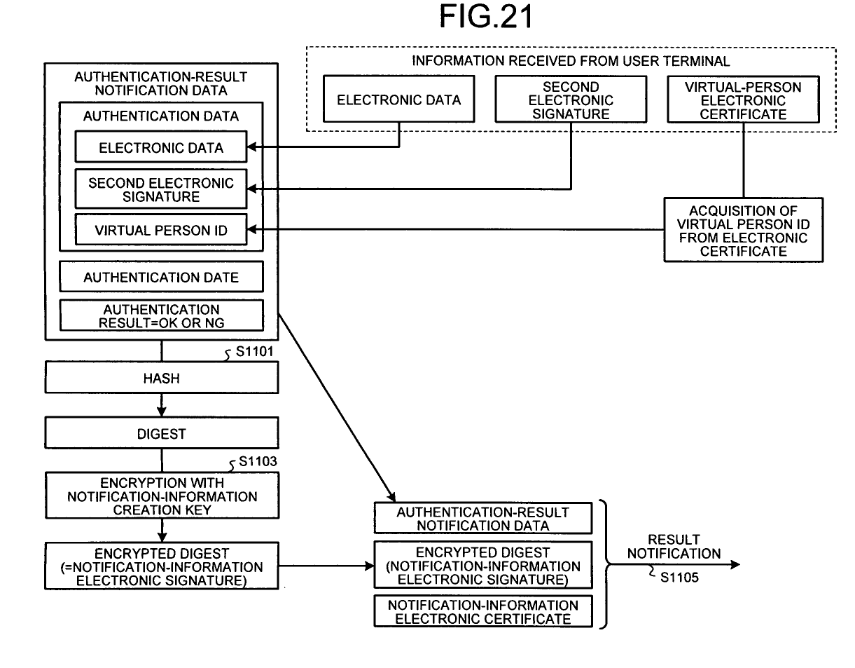

An explanation will be given for the authentication-result notification information generation operation performed by the virtual-person management device 50 depicted in FIG. 19 with reference to FIG. 21. FIG. 21 is a schematic diagram for explaining the authentication-result notification information generation operation performed by the virtual-person management device 50 as depicted in FIG. 19.

As depicted in FIG. 21, after performing the second authentication operation, the authenticating unit 515 included in the virtual-person management device 50 hashes authentication-result notification data by using the hash function thereby generating a digest (Step S1101). The authentication-result notification data includes authentication data, authentication time and date, and a second authentication result (OK or NG). The authentication data includes the electronic data, the second electronic signature, and the virtual person ID contained in the virtual-person electronic certificate included in the second authentication request notification received from the user terminal B.

The authenticating unit 515 included in the virtual-person management device 50 then encrypts the digest generated at Step S1101 with a notification-information creation key thereby generating an encrypted digest (Step S1103). The encrypted digest corresponds to “notification-information electronic signature”.

The transmitting unit 114 included in the virtual-person management device 50 transmits information including the authentication-result notification data, the encrypted digest (the notification-information electronic signature), and the notification-information electronic certificate to the user terminal B (Step S1105). Thus, the user terminal B can authenticate the authentication-result notification data received from the virtual-person management device 50.

As described above, in the virtual-person management system 1, because the common-key encryption method is employed as the encryption method performed between the service providing device 40 and the user terminal 30 of the third person, it is possible to conceal the second signature common key used for the second authentication operation from the third person.

It is effective to configure other embodiments by applying the components, the representations, and arbitrary combinations of the components of the electronic-data authentication method disclosed in the present application to a method, an apparatus, a system, a storage medium, a data structure, and the like.

According to the present invention, it is possible to conceal the first signature-authentication key corresponding to the first signature-creation key used by the virtual person from the third person.

Specifically, according to the present invention, it is possible to achieve an effect that the electronic data provided by the virtual person anonymously used on the network is authenticated while anonymity of the virtual person is ensured.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An electronic-data authentication method for authenticating electronic data provided by a virtual person anonymously used on a network, performed by a virtual-person management system including a user terminal, a user management device, and a virtual-person management device, the electronic-data authentication method comprising:
receiving, by the virtual-person management device, the electronic data, a first electronic signature generated by encrypting the electronic data with a first signature-creation key, and an virtual person ID for uniquely identifying the virtual person from the user terminal;
authenticating, by the user management device, the first electronic signature received at the receiving by using a first signature-authentication key corresponding to the first signature-creation key;
generating, by the virtual-person management device, a second electronic signature by encrypting the electronic data received at the receiving with a second signature-creation key issued for the virtual person; and
transmitting, by the virtual-person management device, the second electronic signature to the user terminal.

2. The electronic-data authentication method according to claim 1, further comprising requesting, by the virtual-person management device, a predetermined organization to issue an electronic certificate for authenticating a second signature-authentication key corresponding to the second signature-creation key thereby acquiring the electronic certificate, wherein
the transmitting includes transmitting the electronic certificate acquired at the requesting as well as the second electronic signature.

3. The electronic-data authentication method according to claim 1, further comprising issuing, by the virtual-person management device, an electronic certificate for authenticating a second signature-authentication key corresponding to the second signature-creation key, wherein
the transmitting includes transmitting the electronic certificate issued at the issuing as well as the second electronic signature.

4. The electronic-data authentication method according to claim 2, wherein the second signature-creation key is identical to the second signature-authentication key.

5. The electronic-data authentication method according to claim 3, wherein the second signature-creation key is identical to the second signature-authentication key.

6. The electronic-data authentication method according to claim 1, wherein the first signature-creation key is identical to the first signature-authentication key.

7. The electronic-data authentication method according to claim 1, wherein the authenticating includes
acquiring, by using the virtual person ID received at the receiving, the first signature-authentication key that is previously stored in association with the virtual person ID, and
determining that the first electronic signature is authentic if a digest generated by decrypting the first electronic signature with the first signature-authentication key is identical to a digest generated by hashing the electronic data received at the receiving by using a hash function.

8. An electronic-data authentication method for authenticating electronic data provided by a virtual person anonymously used on a network, performed by a virtual-person management system including a user terminal, a user management device, a virtual-person management device, and a service providing device, the electronic-data authentication method comprising:
receiving, by the service providing device, the electronic data, a first electronic signature generated by encrypting the electronic data with a first signature-creation key, and an virtual person ID for uniquely identifying the virtual person from the user terminal;
receiving, by the virtual-person management device, the electronic data, the first electronic signature, the virtual person ID from the service providing device,
authenticating, by the user management device, the first electronic signature by using a first signature-authentication key corresponding to the first signature-creation key;
generating, by the virtual-person management device, a second electronic signature by encrypting the electronic data received by the virtual-person management device with a second signature-creation key issued for the virtual person; and
transmitting, by the virtual-person management device, the second electronic signature to the service providing device.

9. An electronic data authenticating system for authenticating electronic data provided by a virtual person anonymously used on a network, comprising:
a user terminal;
a virtual-person management device that includes a receiving unit configured to receive the electronic data, a first electronic signature generated by encrypting the electronic data with a first signature-creation key, and an virtual person ID for uniquely identifying the virtual person from the user terminal; and
a user management device that includes an authenticating unit configured to authenticate the first electronic signature received by the virtual-person management device by using a first signature-authentication key corresponding to the first signature-creation key, wherein
the virtual-person management device further includes an generating unit configured to generate a second electronic signature by encrypting the received electronic data with a second signature-creation key issued for the virtual person, and a transmitting unit configured to transmit the second electronic signature to the user terminal.
